(19) United States
(12) Patent Application Publication
(10) Pub. No.: US 2024/0157268 A1
(43) Pub. Date: May 16, 2024

(54) PROCESS AND DEVICE FOR DISTILLING CARBON DIOXIDE

(71) Applicant: L'Air Liquide, Societe Anonyme pour l'Etude et l’Exploitation des Procedes Georges Claude, Paris (FR)

(72) Inventors: Mathieu LECLERC, Champigny Sur Marne (FR); Laurette MADELAINE, Champigny Sur Marne (FR)

(73) Assignee: L'Air Liquide, Societe Anonyme pour l'Etude et l’Exploitation des Procedes Georges Claude, Paris (FR)

(21) Appl. No.: 18/388,358

(22) Filed: Nov. 9, 2023

(30) Foreign Application Priority Data
Nov. 10, 2022 (FR) FR 2211747

(51) Int. Cl. B01D 3/00; B01D 3/32; B01D 53/00; C01B 32/50

(52) U.S. Cl. CPC B01D 3/007; B01D 3/32; B01D 53/002; C01B 32/50

(57) ABSTRACT

In a process for distilling a gas mixture of CO2 and at least one component lighter than CO2, a partially purified liquid CO2 stream is withdrawn at an intermediate level of the distillation column at least one theoretical plate below the top of the distillation column and at least one theoretical plate above the bottom of the distillation column and the stream extracted at the intermediate level of the distillation column is vaporized by heat exchange with the gas mixture, with which it is then compressed.

### CROSS REFERENCE TO RELATED APPLICATIONS

This application claims the benefit of priority under 35 U.S.C. § 119 (a) and (b) to French patent application No. FR2211747, filed Nov. 10, 2022, which is herein incorporated by reference in its entirety.

### FIELD OF THE INVENTION

The present invention relates to a process and an apparatus for distilling a mixture of carbon dioxide and at least one component lighter than carbon dioxide, such as oxygen, argon, nitrogen, carbon monoxide, methane, hydrogen, ethane or another hydrocarbon, etc.

### BACKGROUND OF THE INVENTION

The production of food-grade CO2 requires advanced purification of liquid CO2, which requires significant investment and/or energy consumption.

In processes for cryogenically capturing CO2 or for liquefying CO2, the integration and the optimization of a distillation step so as to eliminate hydrocarbons (particularly ethane) from the CO2 is therefore key to optimizing the costs of CO2 capture.

In cryogenic CO2 capture processes, the cold at the lowest temperatures generally comes from the expansion of liquid CO2 at a pressure close to its triple point and from its vaporization against the stream to be cooled.

This CO2 most often comes from the last step of purification of the treated stream from which the CO2 has been extracted. In particular, in the case of advanced purification, it originates from the bottom of the distillation column. The overhead gas from the column is most often recycled to the compressor of the stream to be purified upstream of the cryogenic separation or discharged from the process as residual gas.

In the case of liquid CO2 production, the only liquid withdrawn is the bottom liquid and no liquid is withdrawn from the distillation column at an intermediate point of the column.

### SUMMARY OF THE INVENTION

Certain embodiments of the invention make it possible to reduce the energy consumption linked to the liquid CO2 distillation by reducing the quantity of reboiling gas injected at the bottom of the distillation column.

According to one subject of the invention, there is provided a process for distilling a gas mixture of CO2 and at least one component lighter than CO2, containing the following steps:
i) compression of the gas mixture in a compressor to produce a gas mixture to be cooled
ii) cooling and partial or total condensation of the gas mixture so as to obtain a liquid flow enriched in CO2
iii) sending of the liquid flow enriched in CO2 or a liquid flow formed by enriching the enriched liquid flow even more in CO2 into an upper part of a distillation column to separate said liquid flow into a gas enriched in the at least one lighter component and depleted in CO2 at the top of the column and a liquid rich in CO2 at the bottom of the column, the distillation column comprising an upper part and a lower part, a top and a bottom
iv) sending of a gas flow enriched in CO2 to the bottom of the column so as to generate an upflow in the column
v) extraction of a gas stream depleted in CO2 at the top of the column
vi) extraction of a liquid product rich in CO2 at the bottom of the column
vii) extraction of a partially purified liquid CO2 stream at an intermediate level of the column at least one theoretical plate below the top of the column and at least one theoretical plate above the bottom of the column and
viii) vaporization of the stream extracted at the intermediate level of the column by heat exchange with the gas mixture which is cooled in step ii) and
ix) compression of at least part of the vaporized stream in the compressor with the gas mixture.

According to other optional features:
at least part of the gas stream depleted in CO2 is heated against the gas mixture to cool it according to step ii);
at least part of the gas stream depleted in CO2 is vented to the air;
part of the liquid rich in CO2 is heated against the gas mixture to cool it according to step i) and then is sent to the bottom of the column, constituting the gas flow enriched in CO2 of step iii);
part of the cold energy needed for the distillation is provided by a closed refrigeration cycle;
at least part of the vaporized stream is compressed in a compressor of the closed refrigeration cycle;
the stream withdrawn at an intermediate level is withdrawn between the first and the N/2-th theoretical plate of the column, the column comprising N theoretical plates, the first being at the bottom of the column;
the N-th theoretical plate is at the top of the column;
the stream withdrawn at an intermediate level is withdrawn between the N/4-th and the N/2-th theoretical plate of the column.

According to another subject of the invention, there is provided a Apparatus for distilling a gas mixture of CO2 and at least one component lighter than CO2, comprising:
a distillation column comprising an upper part and a lower part, a top and a bottom;
a compressor to compress the gas mixture;
a heat exchanger to cool and partially or totally condense the compressed gas mixture so as to obtain a liquid flow enriched in CO2;
a line for sending the liquid flow enriched in CO2 or a liquid flow formed by enriching the enriched liquid flow even more in CO2 into an upper part of the distillation column to separate said liquid flow into a gas enriched in the at least one lighter component and depleted in CO2 at the top of the column and a liquid rich in CO2 at the bottom of the column;
a line for sending a gas flow enriched in CO2 to the bottom of the column so as to generate an upflow in the column;
a line for extracting a gas stream depleted in CO2 at the top of the column;
a line for extracting a liquid product rich in CO2 at the bottom of the column;
a line for extracting a partially purified liquid CO2 stream at an intermediate level of the column at least one theoretical plate below the top of the column and at least one theoretical plate above the bottom of the column;
a line for sending the stream extracted at the intermediate level of the column to the heat exchanger to vaporize said stream by indirect heat exchange with the gas mixture which is cooled therein and
a line for sending the vaporized stream from the heat exchanger to the compressor to be compressed therein.

Preferably, the apparatus does not comprise a line connecting the bottom of the column for sending part of the liquid product rich in CO2 to the compressor.

In another embodiment, the invention can relate to a process which may comprise the following features:
injecting the liquid CO2 to be purified into the distillation column
reboiling the liquid obtained at the bottom of the column so as to obtain the CO2 at the required specification
extracting a partially purified liquid CO2 stream at an intermediate level of the column
vaporizing the partially purified liquid CO2 stream (optionally after expansion) against the stream to be treated and/or to be liquefied; and
compressing the partially purified gaseous CO2 stream in a refrigeration cycle compressor and/or in the compressor of the stream to be purified upstream of the cryogenic separation.

This configuration makes it possible to reduce the quantity of vaporized CO2 injected at the bottom of the column since the quantity of liquid to be purified is reduced by the action of the intermediate extraction. This results in the reduction in the quantity vaporized within the column and therefore in the overhead gas flow. As the latter is most often recycled to the compressor of the stream to be purified upstream of the cryogenic separation, the energy consumption is thus reduced. If the overhead gas from the column is considered to be a residue and extracted from the capture unit, this makes it possible to reduce the losses of CO2 at the top of the column, increasing the yield of the unit.

### BRIEF DESCRIPTION OF THE DRAWINGS

Other features and advantages of the invention will become further apparent via, on the one hand, the following description and, on the other hand, several exemplary embodiments given by way of non-limiting indication and with reference to the attached schematic drawings, in which:

FIG. 1 illustrates a process for distilling a gas mixture comprising CO2 and at least one lighter component by partial condensation and distillation.

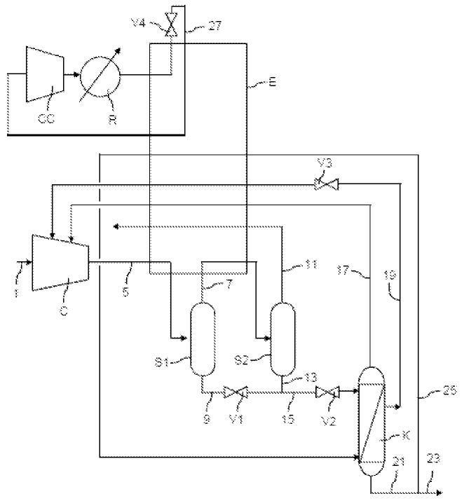

### DETAILED DESCRIPTION OF THE INVENTION

A flow 5 of a gas mixture comprises CO2 and at least one component lighter than CO2 such as oxygen, argon, nitrogen, carbon monoxide, methane, hydrogen, ethane or another hydrocarbon, etc.

This flow 5 may have been compressed in a compressor C or may be available directly at the required pressure, knowing that the distillation pressure is necessarily above 5.2 bar. The flow 5 is partially condensed in a heat exchanger E, leaves the exchanger and is separated in a phase separator S1, forming a liquid 9 enriched in CO2 and depleted in the lighter component and a gas 7 depleted in CO2 and enriched in the at least one light component. The liquid 9 is expanded in a valve V1 and sent to the top of a distillation column K containing plates or packings to promote the exchange of mass and heat. Due to the expansion in the valve, the pressure of the flow 5 will be slightly greater than that of the column K.

If necessary, a second partial condensation step may follow in which the gas 7 is partially condensed in the heat exchanger E and is sent to a second phase separator S2. Formed in this separator are a liquid 13 enriched in CO2 and depleted in the lighter component and a gas 11 depleted in CO2 and enriched in the at least one light component. The liquid 13 is sent to the top of a distillation column K, where it mixes with the flow expanded in the valve V1 to form a liquid 15 which is expanded in a valve V2 upstream of the column K. The gas 11 is heated in the heat exchanger E.

An overhead gas 17 from the column K depleted in CO2 and enriched in the at least one light component is heated in the exchanger E to cool the mixture and is sent to be compressed in the compressor C.

A liquid 19 is withdrawn from the column at least one theoretical plate below the top of the column K and at least one theoretical plate above the bottom of the column K. It is expanded in the valve V3 and vaporized in the exchanger E before being sent to be compressed in the compressor C with the gas mixture to then be separated by partial condensation and distillation.

Here, the liquid 19 is illustrated as being withdrawn in the upper part of the column K. However, according to calculations, a better performance is obtained by withdrawing the liquid 19 in the lower part of the column, that is to say at an intermediate level between the first and the N/2-th theoretical plate of the column, the column comprising N theoretical plates, the first being the bottom of the column.

If the column comprises an uneven number of theoretical plates, the value of N/2 is rounded down to an integer.

Preferably, the stream 19 withdrawn at an intermediate level is withdrawn between the N/4-th and the N/2-th theoretical plate of the column.

If the column comprises an uneven number of theoretical plates or a number that is not a multiple of 4, the value of N/2 is rounded down to an integer and the value of N/4 is rounded up to an integer.

A liquid 21 is withdrawn from the bottom of the column being rich in CO2, therefore containing at least 80 mol % of CO2. Part 23 of this liquid serves as a liquid product and the remainder 25 is vaporized in the heat exchanger E and is sent in gas form to the bottom of the column K to provide reboiling, without having been heated in the heat exchanger E.

Cold energy for the process may be provided by a closed refrigeration circuit, comprising a cycle compressor CC and a cooler R. The cycle fluid is preferably CO2.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

What is claimed is:

1. A process for distilling a gas mixture of CO2 and at least one component lighter than CO2, the process comprising the steps of:
i) compressing the gas mixture in a compressor to produce a compressed gas mixture;
ii) cooling and at least partially condensing the compressed gas mixture to produce a liquid flow enriched in CO2;
iii) sending the liquid flow enriched in CO2 or a liquid flow derived therefrom into an upper portion of a distillation column to separate said liquid flow into a gas enriched in the at least one lighter component and depleted in CO2 at a top of the column and a liquid rich in CO2 at a bottom of the column;
iv) sending a gas flow enriched in CO2 to a bottom portion of the column so as to generate an upflow in the distillation column;
v) extracting a gas stream depleted in CO2 from the top of the distillation column;
vi) extracting a liquid product rich in CO2 from the bottom of the distillation column;
vii) extracting a partially purified liquid CO2 stream at an intermediate level of the distillation column at least one theoretical plate below the top of the distillation column and at least one theoretical plate above the bottom of the distillation column;
viii) vaporizing the partially purified liquid CO2 stream extracted at the intermediate level of the distillation column by heat exchange with the compressed gas mixture in step ii); and
ix) compressing at least part of the vaporized stream in the compressor with the gas mixture.

2. The process according to claim 1, wherein at least part of the gas stream depleted in CO2 is heated against the compressed gas mixture to cool the compressed gas mixture according to step ii).

3. The process according to claim 2, wherein, after heating, the at least part of the gas stream depleted in CO2 is compressed in the compressor with the gas mixture.

4. The process according to claim 1, wherein at least part of the gas stream depleted in CO2 is vented to the air.

5. The process according to claim 1, wherein part of the liquid rich in CO2 is heated against the compressed gas mixture to cool it according to step i) and then is sent to the bottom of the distillation column, constituting the gas flow enriched in CO2 of step iii).

6. The process according to claim 1, wherein part of the cold energy needed for the distillation is provided by a closed refrigeration cycle.

7. The process according to claim 6, wherein at least part of the vaporized stream is compressed in a compressor of the closed refrigeration cycle.

8. The process according to claim 1, wherein the stream withdrawn at an intermediate level is withdrawn between the first and the N/2-th theoretical plate of the distillation column, the distillation column comprising N theoretical plates, the first being at the bottom of the distillation column.

9. The process according to claim 1, wherein the stream withdrawn at an intermediate level is withdrawn between the N/4-th and the N/2-th theoretical plate of the distillation column.

10. An apparatus for distilling a gas mixture of CO2 and at least one component lighter than CO2, the apparatus comprising:
a distillation column comprising an upper part, a lower part, a top, and a bottom;
a compressor configured to compress the gas mixture;
a heat exchanger connected to the compressor to cool and partially or totally condense the gas mixture so as to obtain a liquid flow enriched in CO2;
a first line configured to send the liquid flow enriched in CO2 or a liquid flow formed by enriching the enriched liquid flow even more in CO2 into an upper part of the distillation column to separate said liquid flow into a gas enriched in the at least one lighter component and depleted in CO2 at the top of the distillation column and a liquid rich in CO2 at the bottom of the distillation column;
a second line configured to send a gas flow enriched in CO2 to the bottom of the distillation column so as to generate an upflow in the distillation column;
a third line configured to extract a gas stream depleted in CO2 at the top of the distillation column;
a fourth line configured to extract a liquid product rich in CO2 at the bottom of the distillation column;
a fifth line configured to extract a partially purified liquid CO2 stream at an intermediate level of the distillation column at least one theoretical plate below the top of the distillation column and at least one theoretical plate above the bottom of the distillation column;
a sixth line configured to send the stream extracted at the intermediate level of the distillation column to the heat exchanger to vaporize said stream by indirect heat exchange with the gas mixture which is cooled; and
a seventh line configured to send the vaporized stream from the heat exchanger to the compressor to be compressed therein.

11. The apparatus according to claim 10, further comprising an absence of a line connecting the bottom of the distillation column to the compressor that is configured to send part of the liquid product rich in CO2 to the compressor.
